(19) United States
(12) Patent Application Publication
(10) Pub. No.: US 2012/0232175 A1
(43) Pub. Date: Sep. 13, 2012

(54) PET FOAM ARTICLES AND RELATED METHODS

(75) Inventors: Mark E. Lindenfelzer, Milton, MA (US); Jere R. Anderson, Newburyport, MA (US); Samuel E. Dix, Newburyport, MA (US)

(73) Assignee: MuCell Extrusion, LLC, Woburn, MA (US)

(21) Appl. No.: 13/046,607

(22) Filed: Mar. 11, 2011

(51) Int. Cl. C08G 63/183; B29C 51/02; C08J 9/04

(52) U.S. Cl. 521/79; 521/182; 264/239

(57) ABSTRACT

PET foam articles and methods of forming the same are described herein. Processing conditions may be controlled to form PET foam sheets having desirable characteristics.

### FIELD OF INVENTION

The invention relates generally to polymeric foam and more particularly to polyethylene terephtalate (PET) foam and related methods.

### BACKGROUND OF INVENTION

In general, polymeric foams include a plurality of cells (or voids) formed within a polymer matrix. Microcellular foams (or microcellular materials) are polymeric foams which have very small cell sizes and high cell densities. By replacing solid polymer with voids, polymeric foams use less raw material than solid polymer for a given volume. Thus, raw material savings increase as the density of a foam decreases.

Polyethylene terephthalate (PET) is a thermoplastic polymer resin of the polyester family. PET includes polymerized units of the monomer ethylene terephthalate, with repeating C₁₀H₈O₄ units.

PET foams have been used in a number of applications including packaging. For example, PET foam sheets may be thermoformed into packages such as trays, containers and the like. In some applications, it is desirable to produce PET foams at low densities to take advantage of the associated material cost savings. However, one limitation when processing low density PET foam sheets has been the presence of sheet corrugation which can prevent the sheets from being processed into thermoformed articles having sufficient surface quality and/or appearance.

Accordingly, low density PET foam sheets that are suitable for thermoforming, as well as proceseses for making the same would be desirable.

### SUMMARY OF INVENTION

PET foam articles and methods of forming the same are provided.

In one aspect, a method of forming a PET foam article is provided. The method comprises conveying a stream of PET polymeric material and blowing agent in an extruder. The blowing agent is a mixture comprising carbon dioxide and nitrogen. The ratio of carbon dioxide to nitrogen is between 4:1 and 1:1. The method further comprises extruding the stream to form a PET polymeric foam extrudate.

In one aspect, a PET foam article is provided. The article comprises a PET foam sheet having a density of less than 0.35 g/cm³. The foam sheet has an average cell size of less than 150 microns and is substantially free of corrugation.

Other aspects, embodiments and features of the invention will become apparent from the following detailed description of the invention when considered in conjunction with the accompanying drawings. The accompanying figures are schematic and are not intended to be drawn to scale. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention. All of the patent publications incorporated herein by reference are incorporated herein by references in their entireties. In cases of conflict or inconsistency between the disclosure of an incorporated reference and the present specification, the present specification should control.

### BRIEF DESCRIPTION OF THE DRAWINGS

FIG. 1 shows an extrusion system suitable for producing PET foam sheet according to an embodiment.

FIG. 2A illustrates a die which may be used in connection with the extrusion system of FIG. 1.

FIG. 2B is a section of the die shown in FIG. 2A.

FIG. 3 shows an SEM of a PET foam sheet produced according to techniques of the invention as described in Example 1.

### DETAILED DESCRIPTION

PET foam articles and methods of forming the same are described herein. As described further below, processing conditions may be controlled to form PET foam sheets having desirable characteristics. For example, an extrusion process using a blowing agent mixture (e.g., mixture of N₂ and CO₂) may be used to achieve the desirable characteristics. The PET foam sheets may have a low density and small cell sizes, while being substantially free of corrugation. Such foam sheets may be readily thermoformed into thermoformed articles having excellent mechanical properties and a high quality surface, while offering the advantage of material cost savings associated with a low density foam. The thermoformed articles can be used in a variety of applications including packaging applications such as trays and containers.

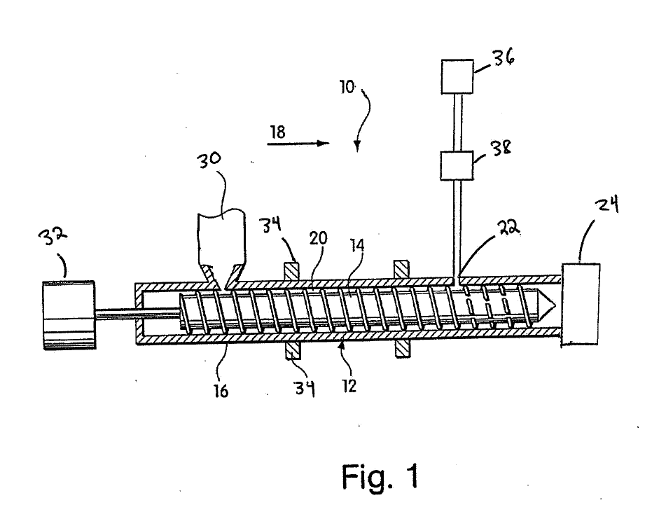

Referring now to FIG. 1, an extrusion system 10 for producing the PET foam sheet is illustrated schematically. The system includes an extruder 12 which houses a screw 14 that rotates within a barrel 16 to convey, in a downstream direction 18, polymeric material in a processing space 20 between the screw and the barrel. Blowing agent is introduced into the stream of polymeric material, for example, through a blowing agent port 22. As noted above and described further below, the process may involve using a mixture of more than one blowing agent (e.g., N₂ and CO₂).

The stream of polymeric material and blowing agent is extruded through a die 24 fluidly connected to the processing space and fixed to a downstream end of the barrel. The die can be configured to form an annular foam extrudate which may be slit to form a sheet; or, in some embodiments, the extrudate may be in sheet form exiting the die. Suitable take-up equipment downstream of the die may include one or more rollers which collect the sheet. The sheet may be further processed as desired to form suitable articles. For example, in some embodiments, the sheets are further processed using known thermoforming techniques to form thermoformed articles.

It should be understood that FIG. 1 depicts a representative extrusion system though other types of extrusion systems may also be used to produce the foam sheet. It should also be understood that the PET foam sheets may be further processed according to techniques other than thermoforming.

The PET polymeric material may be introduced into the extruder using a standard hopper 30. The screw is connected, at its upstream end, to a drive motor 32 which rotates the screw within the barrel. Positioned along the barrel are temperature control units 34. The control units can be electrical heaters, can include passageways for temperature control fluid, and or the like. Units can be used to heat a stream of polymeric material within the barrel to facilitate melting, and/or to cool the stream to control viscosity. The temperature control units can operate differently at different locations along the barrel, that is, to heat at one or more locations, and to cool at one or more different locations. Any number of temperature control units can be provided. Temperature control units also can be supplied to heat the die to which the extrusion system is connected.

In a typical process, PET polymeric material in pellet form is introduced into the polymeric processing space from the hopper. The polymeric material is conveyed in a downstream direction as the screw rotates. Heat and shear forces arising from the rotating screw, act to soften the pellets. Eventually, the softened pellets have been gelated, that is, welded together to form a uniform fluid stream substantially free of air pockets.

As noted above, the methods involve using a blowing agent. As shown in FIG. 1, physical blowing agent may be introduced into the stream from a blowing agent source (or sources) 36 connected to the blowing agent port. In certain preferred embodiments, the blowing agent is a mixture of more than one type of blowing agent. For example, the blowing agent may be a mixture of nitrogen and carbon dioxide. These blowing agents may be in the supercritical state in the extruder. When a mixture of blowing agents is used, the blowing agents may be provided from a single source that supplies the mixture; or, the blowing agents to be mixed may be provided from separate sources. When separate sources are used, the blowing agents may be mixed at any suitable point including upstream of the blowing port (e.g., in the conduit), at the blowing agent port (e.g., multiple inlet to the same port), or may be introduced separately through separate ports into the polymer material in the extruder and mixed in the extruder along with the polymeric material.

A metering device 38 may be provided between the blowing agent source and the port. In cases which utilize multiple sources, each source may include a metering device. The metering device can be used to meter the blowing agent so as to control the amount of the blowing agent in the polymeric stream within the extruder to maintain a level of blowing agent at a particular level. In some preferred embodiments, the device meters the mass flow rate of the blowing agent.

It has been discovered that certain amounts and/or ratios of nitrogen and carbon dioxide may be particularly conducive to forming PET foam sheets having desirable characteristics (e.g., small cell size, low density, substantially free of o corrugation).

For example, it may be preferable for the amount of carbon dioxide to be less than 2% by weight of polymeric stream and blowing agent; in some embodiments, the amount of carbon dioxide may be less than 1% by weight of polymeric stream and blowing agent; and, in some embodiments, the amount of carbon dioxide may be less than 0.5% by weight of polymeric stream and blowing agent.

In some embodiments, it may be preferable for the amount of nitrogen to be less than 2% by weight of polymeric stream and blowing agent; in some embodiments, the amount of nitrogen may be less than 1% by weight of polymeric stream and blowing agent; in some embodiments, the amount of nitrogen may be less than 0.5% by weight of polymeric stream and blowing agent; and, in some embodiments, the amount of nitrogen may be less than 0.25% by weight of polymeric stream and blowing agent.

The total blowing agent percentage in the stream (e.g., the total weight percentage of the blowing agent mixture in the stream) may be less than 4% by weight of polymeric stream and blowing agent; in some embodiments, the total blowing agent percentage in the stream may be less than 2% by weight, or less than 1% by weight, of polymeric stream and blowing agent.

In some embodiments, it may be preferable for the weight percentage of carbon dioxide in the mixture to exceed the weight percentage of nitrogen in the mixture. For example, the ratio of the weight percentage of carbon dioxide in the mixture to nitrogen in the mixture may be between 4:1 and 1:1; in some embodiments, the ratio of the weight percentage of carbon dioxide in the mixture to nitrogen in the mixture may be between 3:1 and 1:1; in some embodiments, the weight percentage of carbon dioxide in the mixture to nitrogen in the mixture is between 4:1 and 2:1; in some embodiments, the weight percentage of carbon dioxide in the mixture to nitrogen in the mixture is between 3.5:1 and 2:1.

It should be understood that certain embodiments may use other types of physical blowing agents known to those of ordinary skill in the art such as hydrocarbons, chlorofluorocarbons, and the like. Such blowing agents, for example, may be combined with nitrogen and/or carbon dioxide in certain cases.

Although the blowing agent port can be located at any of a variety of locations along the barrel, according to some embodiments it is located just upstream from a mixing section of the screw and at a location of the screw where the screw includes unbroken flights. Blowing agent port configurations which may be suitable in some embodiments have been described in U.S. Pat. No. 6,284,810 which is incorporated herein by reference in its entirety. U.S. Pat. No. 6,284,810 also describes extrusion systems which may be suitable in some embodiments. In some embodiments, one or more blowing agent ports may be utilized which include one or more orifices. However, certain systems may have a single blowing agent port and/or a single orifice.

In some embodiments, a single-phase solution of blowing agent and polymer may be formed in the polymer processing space in the extruder. Formation of a single-phase solution may be particularly conducive to forming a foam structure having small cell sizes, as described further below. The single-phase solution may be nucleated upon being extruded through the die. For example, the solution may experience a rapid pressure drop which induces nucleation when passing through the die.

It should be understood that, in some embodiments, a blowing agent and polymer mixture which is not a single-phase solution may be extruded through the die. Such embodiments, however, may not be as well-suited for forming small cell PET foams and/or low density PET foams and/or PET foam sheets being substantially free of corrugation.

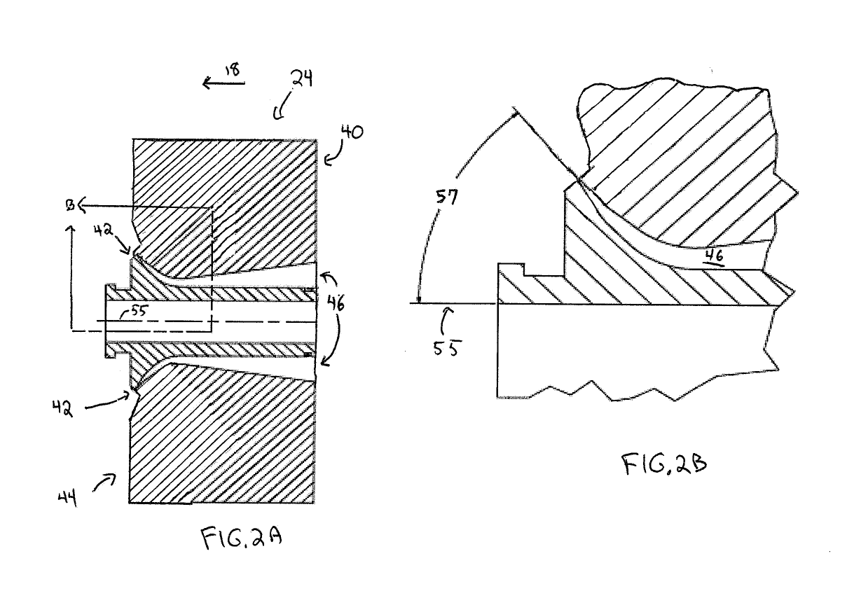

FIGS. 2A and 2B illustrate die 24 which may be used in connection with the extrusion system according to an embodiment. As noted above, the polymer and blowing agent stream is extruded through the die. The die includes an upstream end 40 which can be mounted to the end of the barrel and a die outlet 42 at a downstream end 44 of the die. The die includes an inner passageway 46 which is fluidly connected the polymer processing space in the extruder and extends to the die outlet. In the illustrative embodiment, the inner passageway has an annular shape.

The passageway has a shape and dimensions (die geometry) to control the shape of the extrudate. In certain preferred embodiments, the die geometry may be selected to provide conditions that are conducive to forming the desired PET foam characteristics (e.g., small cell size, low density, substantially free of corrugation).

In some embodiments, the inner passageway may have an orientation that is not parallel with the center line 55 of the die. For example, the inner passageway may have a center line that extends at an angle with respect to the center line of the die approaching the die outlet. As shown, the inner passageway may extend at an angle 57 away from the center line. The angle may be, for example, between 0° and 90°; and, in some cases, between 30° and 60°.

In some embodiments, the die gap may converge in a downstream direction approaching the die outlet. That is, the die gap may decrease in a downstream direction approaching the die outlet. The die gap may converge with a taper angle. The taper angle may be, for example, between 2° and 30°; and, in some cases, between 10° and 25°. In embodiments that include a converging die gap, the gap may converge to a dimension of less than or equal to 0.050 inch (e.g., 0.005 inch to 0.05 inch); and in some cases, less than or equal to 0.040 inch (e.g., 0.004 inch to 0.04 inch).

The above-described die geometry can influence the nucleation of the polymer and blowing agent stream (e.g., single-phase solution of polymer and blowing agent).

The PET foams (and polymeric materials) described herein have PET as their major component. The term “PET” has its ordinary meaning in the art and, in general, refers to a polymer having polymerized units of the monomer ethylene terephthalate, with repeating C₁₀H₈O₄ units. In some embodiments, the foams (and polymeric materials) may include additional components such as other types of polymeric materials (e.g., blended with PET), additives (e.g., nucleating agents such as talc, carbon black), processing aids, and the like. Since the PET foam sheets and articles are produced using physical blowing agents, the resulting sheets and articles may be substantially free of residual chemical blowing agents or by-product of chemical blowing agent. Such sheets and articles may have certain advantages in some applications over foam sheets and articles produced using chemical blowing agents.

As noted above, in some embodiments, the PET foam sheets and related articles may have small cell sizes. For example, in some embodiments, the PET foam sheets and related articles may be microcellular foams. The PET foams and related articles may have an average cell size of less than 150 micron. The cell size can be determined by examining a representative number of cells using SEM analysis. The average cell size is the numeric mean of the size a representative number of cells. When determining the size of a cell that has different dimensions along one or more axes (length, width, height), the cell size may be calculated as the average of the cell dimensions along each axis (length, width, height). In some embodiments, the average cell size may be less than 100 micron; and, in some embodiments, less than 75 micron.

In some embodiments, the PET foam sheets and articles may have a substantially closed cell structure. This means that a majority of the cells are not interconnected with other cells.

In general, the PET foam sheets and articles may be produced over a wide range of density. The density may be selected depending on the requirements of the application in which the sheet and article is used. In some embodiments, as noted above, it may be preferred to produce low density PET foam sheets and articles. One feature of the techniques described herein is that the enable production of such low density PET foam sheets and articles which still exhibit excellent mechanical properties and are substantially free of corrugation. For example, the density of the foam sheets and articles may be less than 0.35 g/cm³; in some embodiments, the density of the foam sheets and articles may be less than 0.25 g/cm³; and, in some embodiments, the density of the foam sheets and articles may be less than 0.20 g/cm³. In some embodiments, it may be preferable for the foam sheets and articles to have a density of greater than 0.15 g/cm³.

In general, the PET foam sheets and articles may have any suitable thickness. The sheets, for example, generally have a thickness suitable for thermoforming when used in thermoformed article applications. Typical thicknesses may be, for example, between 0.05 inch and 0.10 inch.

Advantageously, the thickness variation across a sheet may be small. For example, the thickness variation between the maximum sheet thickness and the average sheet thickness may be less than 10% and the thickness variation between the minimum sheet thickness and the average sheet thickness is less than 10%. In some embodiments, the thickness variation of the PET foam sheets may be even lower, e.g., less than 5% between the maximum thickness and the average thickness and/or less than 5% between the minimum thickness and the average thickness.

Advantageously, the PET foam sheets and articles described herein may be substantially free of corrugation.

As noted above, the PET foam sheets and articles may have a number of desirable characteristics including excellent mechanical properties. The mechanical properties may include a high modulus, high strengths and the like. The sheets and articles may also have high quality surfaces which may be attractive in appearance and/or may be decorated as desired.

The desirable properties and characteristics enable the PET foam sheets and articles to be used in a variety of applications. In particular, the polymer foam blown films may be used in thermoformed article applications including packaging such as trays, containers and the like.

The function and advantage of these and other embodiments of the present invention will be more fully understood from the example below. The following example is intended to illustrate the benefits of the present invention, but does not exemplify the full scope of the invention.

### Example

This example illustrates the production of PET foam sheets according to techniques of the invention.

A stream of PET polymeric material was created in an extruder. A mixture of carbon dioxide and nitrogen was introduced through a blowing agent port into the stream to form a mixture of blowing agent and PET. The percentage of N₂ was less than 0.25% by weight of the mixture and the percentage of CO₂ was less than 1.0% by weight of the mixture, and the ratio of CO₂ to N₂ was between about 4:1 and 1:1. The mixture was mixed within the extruder to form a single-phase solution. The solution was extruded through a die similar to the one illustrated in FIG. 2. The annular extrudate was processed, including by a slitting operation, to form a PET foam sheet.

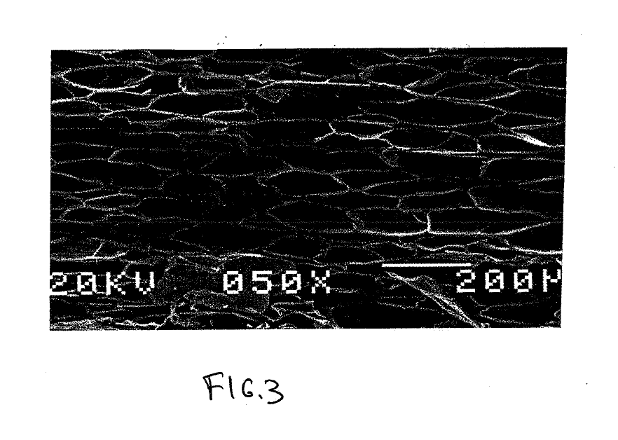

The PET foam sheet was characterized using SEM analysis. FIG. 3 is a copy of an SEM photo illustrating a representative section of the sheet. The average cell size was determined to be about 100 microns. The PET foam sheet had a density of about 0.25 g/cm³. The PET foam sheet was substantially free of corrugation. The foam had high quality surfaces and excellent mechanical characteristics. The PET foam sheet was suitable for thermoforming.

What is claimed:

1. A method of processing PET foam sheet comprising:
conveying a stream of PET polymeric material and blowing agent in an extruder, wherein the blowing agent is a mixture comprising carbon dioxide and nitrogen, wherein the ratio of carbon dioxide to nitrogen is between 4:1 and 1:1;
extruding the stream; and
forming a PET polymeric foam sheet.

2. The method of claim 1, further comprising introducing the blowing agent mixture into the polymeric material in the extruder through a port to form the stream of polymeric material and blowing agent.

3. The method of claim 1, wherein the blowing agent is present in an amount less than about 2.0% by weight of polymeric stream and blowing agent.

4. The method of claim 1, wherein the carbon dioxide is present in an amount less than about 2.0% by weight of polymeric stream and blowing agent.

5. The method of claim 1, wherein the nitrogen is present in an amount less than about 1.0% by weight of polymeric stream and blowing agent.

6. The method of claim 1, wherein the ratio of carbon dioxide to nitrogen is between 3:1 and 1:1

7. The method of claim 1, further comprising forming a single-phase solution from the stream of polymeric material and blowing agent in the extruder.

8. The method of claim 7, further comprising nucleating the single-phase solution by extruding the solution through the die.

9. The method of claim 1, wherein the die has a cross-sectional dimension that converges toward the die outlet.

10. The method of claim 1, wherein the PET foam sheet has an average cell size of less than 150 micron.

11. The method of claim 1, wherein the PET foam sheet has a density of less than 0.35 g/cm³.

12. The method of claim 1, wherein the PET foam sheet is substantially free of corrugation.

13. The method of claim 1, further comprising thermoforming the PET foam sheet to form a thermoformed PET foam article.

14. A PET foam article comprising:
a PET foam having a density of less than 0.35 g/cm³, wherein the foam sheet has an average cell size of less than 150 microns and is substantially free of corrugation.

15. The article of claim 14, wherein the PET foam has a density of less than 0.30 g/cm³.

16. The article of claim 14, wherein the PET foam has an average cell size of less than 100 microns.

17. The article of claim 14, wherein the PET foam article is a sheet.

18. The article of claim 14, wherein the PET foam article is a thermoformed article.
